(19) United States
(12) Patent Application Publication
(10) Pub. No.: US 2011/0274938 A1
(43) Pub. Date: Nov. 10, 2011

(54) Barrier Film Structures

(76) Inventor: Pang-Chia Lu, Pittsford, NY (US)

(21) Appl. No.: 13/143,017

(22) PCT Filed: Feb. 13, 2009
(86) PCT No.: PCT/US09/34075

§ 371 Date: Jun. 30, 2011

(51) Int. Cl. B32B 15/082; B05D 3/06; B05D 3/08; B05D 1/36

(52) U.S. Cl. 428/461; 427/404; 427/576; 427/225

(57) ABSTRACT

A polymeric film structure exhibiting improved barrier properties and which is formed in the absence of a primer. The film structure is produced by coating a surface of a polymeric substrate with a solution of a polyvinyl alcohol-vinyl amine copolymer, an aldehyde-containing crosslinking agent and a crosslinking promoting acid catalyst and metallized with a metal layer. The polymer substrate is made out of polyolefin materials such as polypropylene.

### FIELD OF THE INVENTION

The present invention relates to barrier film structures and, more particularly, to PVOH-based coated polymeric films having a metal layer deposited on thereto for improved barrier properties.

### BACKGROUND OF THE INVENTION

Polymeric film structures are used in many commercial applications. One particularly important application is the food packaging industry. Film structures employed in the food packaging industry are chosen and/or designed to provide characteristics necessary for proper food containment. Such characteristics include water vapor barrier properties, oxygen and gas barrier properties and flavor and aroma barrier properties. One commonly employed structure includes a flexible and durable polymeric film substrate that provides the film structure with structural integrity and water vapor barrier properties, and at least one coating adhered thereto that provides the film structure with oxygen, gas barrier and flavor aroma barrier properties.

For example, coatings of polyvinyl alcohol (“PVOH”) are known to provide a barrier to the transmission of oxygen, and have been applied to various polymeric substrates in the past. PVOH, however, is soluble in water and is therefore susceptible to attack by moisture. In this regard, various attempts have been made to decrease the sensitivity of PVOH to attack by moisture.

One known method of decreasing the sensitivity of a PVOH-based coating to attack by moisture involves the crosslinking of the PVOH. That is, a crosslinking agent and catalyst may be applied along with the PVOH such that the agent interconnects and thereby crosslinks the PVOH molecules as such coating is dried. The crosslinked coating thereafter exhibits increased resistance to attack by moisture as compared to non-crosslinked coatings. As mentioned, a catalyst is typically added to the coating solution to facilitate the crosslinking process.

To ensure adequate bonding between a PVOH-based coating and the underlying substrate, a primer may be used. More particularly, a primer, e.g., polyethyleneimine, is applied to the substrate prior to the application of the PVOH-based coating. The use of primers, however, is not without its disadvantages. For example, the use of a primer increases the number of manufacturing steps and also increases the manufacturing cost of producing the film structure. Moreover, applications may exist in which the presence of a primer in the film structure may negatively impact or limit the use of such structure.

U.S. Pat. No. 4,650,721 discloses a film structure in which a coating of PVOH is applied to a maleic acid anhydride-modified polypropylene substrate and thereafter oriented to affect adhesion therebetween. However, the modification of the substrate increases the number of manufacturing steps and/or increases the manufacturing cost of producing the film structure. Moreover, the modification of the polymeric substrate may negatively impact other film characteristics such as machinability, processability and clarity.

U.S. Pat. No. 5,776,618 discloses a polymeric film structure exhibiting improved barrier properties and which is formed in the absence of a primer. The film structure is produced by coating a surface of a polymeric substrate with a solution of a polyvinyl alcohol-vinyl amine (“PVOH/VAM”) copolymer, an aldehyde-containing crosslinking agent and a crosslinking promoting acid catalyst. The polymer substrate is made out of polyolefin materials such as polypropylene.

There is a need to further improve oxygen and/or moisture barrier for film structures which are formed by the application of a PVOH-based coating to a surface of a polymeric substrate in the absence of a primer and/or use of a modified substrate. A metal coating on a polymeric substrate with at least one PVOH-based coating shows improved barrier properties.

### SUMMARY OF THE INVENTION

The present invention, which addresses the need in the art, relates to a polymeric film structure having improved barrier characteristics. The film structure is produced by the process of coating at least one side of a polymeric substrate with a solution of a polyvinyl alcohol-vinyl amine copolymer, an aldehyde-containing crosslinking agent in an amount sufficient to effect crosslinking throughout said copolymer and a catalytically-effective amount of a crosslinking-promoting acid catalyst, and a metal coating on the outermost surface of the film structure.

In some embodiments, the copolymer includes from about 2% to about 20% of vinyl amine, and preferably about 6% to about 12% of vinyl amine. The aldehyde-containing crosslinking agent is preferably selected from the group consisting of melamine formaldehyde, urea formaldehyde and glyoxal. The crosslinking-promoting acid catalyst is preferably selected from the group consisting of hydrochloric acid, sulfuric acid, phosphoric acid and acetic acid. Finally, the coating solution is preferably coated on the surface of an unmodified polymeric substrate in the absence of a primer layer therebetween.

In other embodiments, the metal coating is made by vacuum deposit of aluminum, gold, or silver.

As a result, the present invention provides a barrier film structure which is formed by the application of a PVOH-based coating to a surface of a polymeric substrate in the absence of a primer layer therebetween and in the absence of the use of a modified polymeric substrate and further having a metal coating on the outmost surface of the film structure. The PVOH-based coating firmly adheres to the surface of the underlying substrate, even in the absence of the primer and/or resin modifier. The PVOH-based coating exhibits a high degree of crosslinking upon drying. Moreover, the metal coated film structure exhibits excellent barrier properties.

### DETAILED DESCRIPTION OF THE INVENTION

The films of the present invention are produced by coating at least one side of a polymeric substrate with a solution of a polyvinyl alcohol-vinyl amine copolymer, an aldehyde-containing crosslinking agent in an amount sufficient to effect crosslinking throughout the polyvinyl alcohol-vinyl amine and a catalytically-effective amount of a crosslinking-promoting acid catalyst. The polyvinyl alcohol-vinyl amine copolymer is thereafter crosslinked to provide an oxygen barrier, i.e., a polymeric layer which resists the transmission of oxygen therethrough. The polyvinyl alcohol-vinyl amine copolymer coated film is then further coated the outermost surface with metal.

The polymeric substrates useful for this disclosure are made from polyolefins. One particularly preferred polyolefin is polypropylene.

It has been discovered herein that a coating solution of polyvinyl alcohol-vinyl amine copolymer and an aldehyde-containing crosslinking agent in the presence of a catalytically-effective amount of a crosslinking-promoting acid catalyst will adhere to an underlying polymeric substrate in the absence of a primer layer therebetween and without the use of a modified polymeric substrate. Stated differently, the need for precoating the surface of the underlying substrate with any of the various known primers (e.g., polyethyleneimine (PEI)) has been eliminated in the present invention. Moreover, this may be accomplished with an unmodified polymeric substrate, i.e., a substrate formed from a polymer which has not been modified by the blending of various components therein in an effort to improve the surface bonding characteristics of the resultant extruded film.

Thus, the aforementioned PVOH-based coating solution may be applied directly to a surface of an unmodified polymeric substrate. This then eliminates the additional manufacturing steps required in the prior art, thus reducing the manufacturing cost of the film structure. Moreover, the removal of the primer and/or modifier components from the film structure allows such structure to be used in a greater variety of applications, while also permitting greater manufacturing flexibility.

The polyvinyl alcohol-vinyl amine copolymer includes from about 2% to about 20% of vinyl amine, and preferably includes about 6% to about 12% of vinyl amine. Polyvinyl alcohol-vinyl amine, including at least one preferred method of manufacture, is discussed in U.S. Pat. No. 5,300,566, assigned to Air Products and Chemical Company. The polyvinyl alcohol-vinyl amine copolymer may also available from Erkol.

Although PVOH-based coatings provide a barrier to the transmission of oxygen, PVOH itself is soluble in water and therefore susceptible to attack by moisture. As a result, PVOH layers which will be exposed to moisture are typically crosslinked. The crosslinking of the PVOH layer substantially reduces its susceptibility to attack by moisture.

In the present invention, an aldehyde-containing crosslinking agent in an amount sufficient to effect crosslinking throughout the polyvinyl alcohol-vinyl amine copolymer is added to the coating solution. The crosslinking agent is preferably selected from the following agents: melamine formaldehyde, urea formaldehyde, glyoxal and agents derived therefrom. The melamine formaldehydes are particularly preferred crosslinking agents. Commercially available melamine formaldehyde crosslinking agents include Cymel 303, Cymel 350, Cymel 373, Parez 613, Parez 617 and Parez 707, available from American Cyanamid Co.

To promote and facilitate the crosslinking of the polyvinyl alcohol-vinyl amine copolymer, a catalytically-effective amount of a crosslinking-promoting acid catalyst is added to the coating solution. The acid catalyst is preferably selected from the following acids: hydrochloric acid (HCL), sulfuric acid (H₂SO₄), phosphoric acid (H₃PO₄) and acetic acid (CH₃COOH). The pH of the coating solution is preferably maintained within the range of from about 1 to about 6, and more preferably at a pH of about 2 to about 4.

The coating solution includes from about 60% to about 95% of the polyvinyl alcohol-vinyl amine copolymer, and more preferably from about 70% to about 80% of the polyvinyl alcohol-vinyl amine copolymer. The coating solution further includes from about 2% to about 40% of the aldehyde-containing crosslinking agent, and more preferably from about 15% to about 30% of the aldehyde-containing crosslinking agent. Finally, the coating solution includes from about 0.1% to about 10% of the crosslinking-promoting acid catalyst, and more particularly from about 0.5% to about 5% of the crosslinking-promoting acid catalyst.

The solution, which is preferably aqueous, is prepared by mixing the polyvinyl alcohol-vinyl amine copolymer with the aldehyde-containing crosslinking agent in a water solution. Thereafter, the acid catalyst is added in an amount sufficient to adjust the pH to about 1-6, and preferably to about 2-4.

In one preferred embodiment, the aqueous solution includes from about 3% to about 20% by weight of solid and, more preferably, from about 5% to about 10% by weight of solid.

The side of the substrate to be coated is preferably surface treated in a conventional manner, e.g., by flame treatment, corona treatment, or other similar treatment. In one particular preferred embodiment, the surface of the substrate to be coated is corona treated such that the surface exhibits a surface tension of from about 35 dynes per centimeter to about 45 dynes per centimeter and, more preferably, about 38 dynes per centimeter.

In some embodiments, the PVOH-based coating of the present invention allows the application of a top coating thereover. For example, an acrylic heat seal coating may be applied to the exposed surface of the PVOH-based coating. In other embodiments, the PVOH-based coating of the present invention allows the application of a metal coating thereover.

The PVOH-based coating of the present invention may be coated by off-line or in-line process. In the off-line coating process, a polyolefinic substrate is formed, optionally subjected to monoaxial orientation or biaxial orientation, then a polyvinyl alcohol-vinyl amine copolymer layer is off-line coated on the polyolefinic substrate with a solution of a polyvinyl alcohol-vinyl amine copolymer, an aldehyde-containing crosslinking agent for crosslinking said copolymer and a catalytically-effective amount of a crosslinking-promoting acid catalyst. The polyvinyl alcohol-vinyl amine copolymer layer coated polyolefinic substrate structure is then metallized with a layer of metal. Prior to the metallization, the polyvinyl alcohol-vinyl amine copolymer layer coated polyolefinic substrate structure may be dried to improve metallization efficiency. In the in-line coating process, a polyolefinic substrate is formed together with a polyvinyl alcohol-vinyl amine copolymer layer coating using a solution of a polyvinyl alcohol-vinyl amine copolymer, an aldehyde-containing crosslinking agent for crosslinking said copolymer and a catalytically-effective amount of a crosslinking-promoting acid catalyst, optionally the polyvinyl alcohol-vinyl amine copolymer coated polyolefinic substrate is subjected to monoaxial orientation or biaxial orientation, then metallized with a layer of metal. The drying step may be skipped because the polyvinyl alcohol-vinyl amine copolymer layer coated polyolefinic substrate structure is typically dried in the orientation process.

The outermost surface of the film structure is coated with a metal layer. In some embodiments, the outermost surface is the surface coated with a PVOH-based coating. Application of a metal coating layer may be accomplished by vacuum deposition, or any other metallization technique, such as electroplating or sputtering. The metal of the metal coating layer may be aluminum, or any other metal capable of being vacuum deposited, electroplated, or sputtered, such as, for example, gold, zinc, copper, or silver, chromium, or mixtures thereof.

One or both of the outer exposed surfaces of the film structure may be surface-treated to increase the surface energy of the film. The surface treatment may aid in rendering the film more receptive to metallization, coatings, printing inks, and/or lamination. The surface treatment can be carried out according to any method known in the art. Preferred methods include, but are not limited to, corona discharge, flame treatment, plasma treatment, chemical treatment, or treatment by means of a polarized flame. In some embodiments, the film may first be treated, for example by flame treatment, and then be treated again in the metallization chamber, for example by plasma treatment, immediately prior to being metallized.

The following examples illustrate the enhanced barrier characteristics of films produced in accordance with the present invention.

### Example

Water vapor transmission rates (WVTR) were measured according to ASTM F-1249 procedure. Oxygen transmission rates (OTR) were measured according to ASTM D3985 test procedure. Optical density (OD) results were measured according to American National Standards Institute (ANSI) ANSI/NAPM IT2.19 test procedure.

Samples 1 to 6 were produced as described hereinbelow and measured for % crosslinking (after 1 hr. off line) and OTR (cc/100 in²/24 hr. @ 100° F. and 90% RH) and set forth hereinbelow.

The polymeric substrate used in each of Samples 1-6 was an oriented polypropylene film having a thickness of 0.9 mil. The polypropylene substrate was corona treated whereby the treated surface exhibited a surface energy of 38 dynes per centimeter.

The coating solutions were aqueous solutions of PVOH (ELVANOL 7130), MD6 (PVOH/VAM, 6% vinyl amine as Erkol L6), or MD12 (PVOH/VAM, 12% vinyl amine as Erkol L6) as identified below, melamine formaldehyde (Parez 707) in the amount identified below and a phosphoric acid catalyst (H₃PO₄) in an amount effective to adjust the pH of the coating solution to approximately 2.5. All PVOH and PVOH/VAM coatings were made around 6% and 8% solids. The coating solutions were applied to achieve desired coat weight of 0.3 or 0.6 g/msi.

The Line Conditions were:
Top Coat: Oven Temp=240° F., a 130-Quad gravure cylinder, Line speed=125 feet per minute;
Priming: Samples 1 and 2 used the PEI primer at 0.07%, Oven Temp=220° F.

The samples have the following structures:

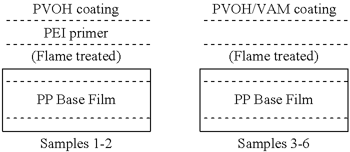

The following table lists coating compositions and coating weight of samples 1-6.

| Sample No. | Coating | Coating Wt. g/msi |
|---|---|---|
| 1 | PVOH | 0.3 |
| 2 | PVOH | 0.6 |
| 3 | MD6 | 0.3 |
| 4 | MD6 | 0.6 |
| 5 | MD12 | 0.3 |
| 6 | MD12 | 0.6 |

The following table lists barrier properties of samples 1-6 (unmetallized and metallized). Metallization of samples 2 and 5 were conducted with vacuum depositing aluminum by controlling OD.

| Unmetallized | | | | Metallized | | |
|---|---|---|---|---|---|---|
| | WVTR | OTR | OTR | WVTR | OTR | |
| | 100 F., | 73 F., | 73 F., | 100 F., | 73 F., | OD |
| | 90% RH | 0% RH | 50% RH | 90% RH | 0% RH | 20-point |
| | g/m²/day | cc/m²/day | cc/m²/day | g/m²/day | cc/m²/day | average |
| 1 | 4.00 | 3.19 | 3.13 | 0.66 | 1.11 | 2.06 |
| 2 | 3.60 | 0.94 | 0.99 | not tested | not tested | not |
| | | | | | | tested |
| 3 | 3.87 | 3.41 | 4.14 | not tested | not tested | not |
| | | | | | | tested |
| 4 | 3.56 | 0.36 | 1.12 | not tested | not tested | not |
| | | | | | | tested |
| 5 | 3.84 | 2.06 | 3.93 | 0.89 | 2.01 | 1.98 |
| 6 | 3.47 | 0.26 | 1.04 | not tested | not tested | not |
| | | | | | | tested |

As is readily apparent from the data set forth in the above table, Sample 5 (metallized) formed in accordance with the present invention exhibits excellent oxygen barrier properties.

Thus, while there have been described what are presently believed to be the preferred embodiments of the invention, those skilled in the art will realize that various changes and modifications may be made to the invention without departing from the spirit of such invention. All such changes and modifications which fall within the scope of the invention are therefore intended to be claimed.

1. A polymeric film structure produced by the process comprising:
(a) forming a polyvinyl alcohol-vinyl amine copolymer layer on a polyolefinic substrate with a solution of a polyvinyl alcohol-vinyl amine copolymer, an aldehyde-containing crosslinking agent for crosslinking said copolymer and a catalytically-effective amount of a crosslinking-promoting acid catalyst; then
(b) coating the side of said polyvinyl alcohol-vinyl amine copolymer layer which is on the opposite side of said polyolefinic substrate with a layer of metal.

2. The film structure according to claim 1, wherein said copolymer includes from about 2% to about 20% by weight of vinyl amine.

3. The film structure according to claim 1, wherein said aldehyde-containing crosslinking agent is selected from the group consisting of melamine formaldehyde, urea formaldehyde and glyoxal.

4. The film structure according to claim 1, wherein said crosslinking-promoting acid catalyst is selected from the group consisting of hydrochloric acid, sulfuric acid, phosphoric acid and acetic acid.

5. The film structure according to claim 1, wherein said solution has a pH level of from about 1 to about 6.

6. The film structure according to claim 1, wherein said solution is coated on said substrate in the absence of a primer.

7. The film structure according to claim 1, wherein said solution is aqueous.

8. The film structure according to claim 1, wherein said solution includes from about 70% to about 80% by weight of said copolymer, from about 15% to about 30% by weight of said crosslinking agent and from about 0.5% to about 5% by weight of said acid catalyst.

9. The film structure according to claim 1, wherein said at least one side of said polymeric substrate is subjected to a surface treating process selected from the group consisting of corona discharge, plasma treatment and flame treatment.

10. The film structure according to claim 1, wherein said polyolefinic substrate is polypropylene.
